(19) United States
(12) Patent Application Publication
(10) Pub. No.: US 2015/0128222 A1
(43) Pub. Date: May 7, 2015

(54) SYSTEMS AND METHODS FOR SOCIAL MEDIA USER VERIFICATION

(71) Applicant: BUILT-IN-MENLO, INC., MENLO PARK, CA (US)

(72) Inventors: Jason Michael Festa, Menlo Park, CA (US); Matthew Holcombe, Menlo Park, CA (US); Shane Hill, San Francisco, CA (US)

(73) Assignee: BUILT-IN-MENLO, INC., Menlo Park, CA (US)

(21) Appl. No.: 14/151,713

(22) Filed: Jan. 9, 2014

Related U.S. Application Data
(60) Provisional application No. 61/900,294, filed on Nov. 5, 2013.

(51) Int. Cl. H04L 29/06

(52) U.S. Cl. CPC H04L 63/126
USPC 726/4

(57) ABSTRACT

Embodiments of the present disclosure provide an effective, user-friendly approach to help prevent the abuse of social networks by users who misrepresent their age, identity, and/or other information.

### RELATED APPLICATIONS

The present application claims priority to Prov. U.S. Pat. App. Ser. No. 61/900,294, filed Nov. 5, 2013 and entitled “SYSTEMS AND METHODS FOR SOCIAL MEDIA USER VERIFICATION,” the disclosure of which is hereby incorporated herein by reference in its entirety.

### BACKGROUND

The recent rise in popularity of social media networks has dramatically changed the manner in which many people meet and communicate with each other. Unfortunately, some social network users may not provide accurate information about themselves. This issue is particularly prevalent with respect to online predators, who are older individuals misrepresenting their age in order to prey upon younger social network users, as well as with “catfishers” who are individuals that create fake social network accounts for the purpose of pursuing deceptive online romances. Similar misrepresentations are likewise involved in acts of online harassment and abuse, often referred to as “cyber stalking” and “cyber bullying.”

Embodiments of the present disclosure address these and other issues.

### SUMMARY OF THE DESCRIPTION

Embodiments of the present disclosure provide an effective, user-friendly approach to help prevent the abuse of social networks by users who misrepresent their age, identity, and/or other information.

A computer-implemented method according to one embodiment of the present disclosure comprises: requesting, by a computer system, an image of a user of a client device; receiving the image of the user from the client device by the computer system; receiving information regarding the client device by the computer system; and performing, by the computer system, a first verification of the user based on the image of the user and the information regarding the client device. In the event the first verification of the user is unsuccessful, usage of an account associated with the user on a social media network is disabled. The method further includes, in the event the first verification of the user is successful: providing the image of the user to a plurality of members of the social network; soliciting input from the plurality of members of the social network regarding the image of the user; performing a second verification of the user based on the input from the plurality of members of the social network. In the event the second verification of the user is unsuccessful, usage of the account associated with the user on the social network is disabled, and in the event the second verification of the user is successful, usage of the account associated with the user on the social network is enabled.

The present disclosure includes methods and apparatuses which perform these methods, including computing systems which perform these methods, and computer readable media containing instructions that, when executed by computing systems, cause the computing systems to perform these methods.

Other features will be apparent from the accompanying drawings and from the detailed description which follows.

### BRIEF DESCRIPTION OF THE DRAWINGS

A more complete understanding of certain embodiments may be derived by referring to the detailed description and claims when considered in connection with the following illustrative figures.

FIG. 1 is a flow diagram showing an exemplary process according to various embodiments.

FIG. 2 is a block diagram of an exemplary system according to various embodiments.

FIGS. 3-7 are exemplary screenshots depicting features of exemplary embodiments of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any combination and/or subset of the elements of the methods depicted herein may be practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

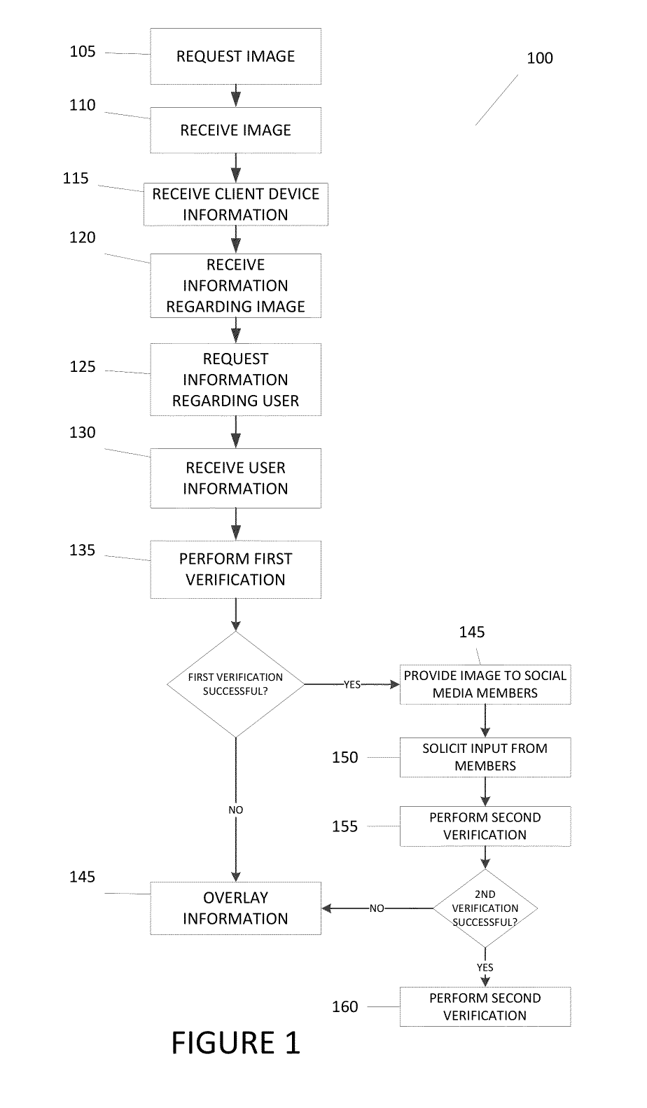

FIG. 1 depicts an exemplary process according to various embodiments of the present disclosure. In FIG. 1, method 100 includes requesting an image from a user of a client device (105), receiving the image (110), receiving information regarding the client device (115), receiving information regarding the image (120), requesting information regarding the user from the user (125), receiving information regarding the user (130), and performing a first verification of the user (135). In the event the first verification is not successful, usage of an account associated with the user on a social media network is disabled (140). In the event the first verification is successful, the image is provided to members of the social media network (145), input is solicited from the members of the social media network (150), and a second verification of the user is performed (155). In the event the second verification is not successful, usage of the account associated with the user on the social media network is disabled (140). In the event the first verification is successful, usage of the account is enabled (160).

Embodiments of the present disclosure may be used to verify the age, identify, and/or other characteristics of a user in a variety of situations. For example, an image of the user may be requested (105) as part of an authentication process when the user logs in to a social media network, as well as in response to a request from the user to access information regarding another member of the social network, or in response to the user attempting to retrieve his or her password.

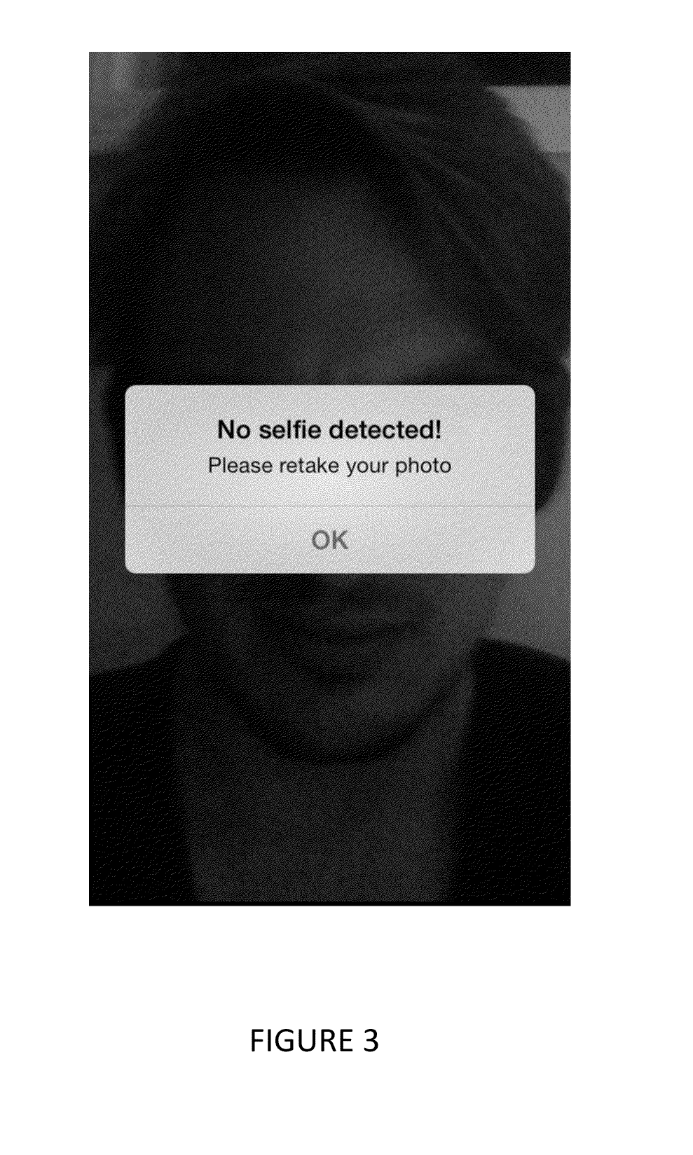

Many client devices (such as smartphones, tablet computers, desktop computers, laptop computers, and others) include, or are coupled to, at least one digital camera. Various embodiments may request that the image of the user be captured using such a camera in response to the request for the image (105). FIG. 3, for example, illustrates an exemplary screenshot of an embodiment of the present disclosure requesting a user to take a “selfie” (i.e., an image of the user taken by the user him/herself). Among other things, requesting that the user take a “selfie” proximate to the request (105) allows embodiments of the present disclosure to determine whether the image matches previous images submitted by the user, as well as to verify other aspects of the user's identity and the client device as discussed in more detail below.

In method 100, the image is received from the client device (110). In some embodiments, the request for the image (105) may be re-sent if the image is not received within a predetermined period of time. Additionally, the user may be blocked from performing further operations on a social network (such as accessing his or her account, viewing information on the social network, communicating with other members of the social network, and the like) until the image is received (110).

In addition to receiving the image, embodiments of the present disclosure may receive information about the client device (115). This information may be collected in any suitable manner, such as via a software application operating on the client device (such as an application for accessing/using a social network). Any desired information regarding the client device may be received, including a manufacturer of the client device, a model of the client device, information regarding a camera coupled to the client device, a unique device identifier for the client device, a telephone number used by the client device, an email address used by the client device, an internet protocol address used by the client device, a media access control address associated with the client device, an integrated circuit card identifier associated with a subscriber identity module in the client device, and/or an international mobile subscriber identifier associated with a subscriber identity module in the client device.

Various embodiments may identify and/or receive any desired information regarding the image of the user (120). For example, meta data contained in the image of the user may be retrieved from the image itself. Information regarding the image may also be received from other sources, such as from the user of the client device (e.g., in response to a request that the user “tag” or otherwise identify people, places, and/or things shown in the image), as well as by performing a web image search to, for example, identify one or more images that are similar to the received image of the user, as well as corresponding information about such images. In this context, embodiments of the present disclosure may identify other images based on any point of similarity with the image of the user received from the client device, such as a common photographer, an image taken by the same device, an image taken in the same location as the user, and other characteristics.

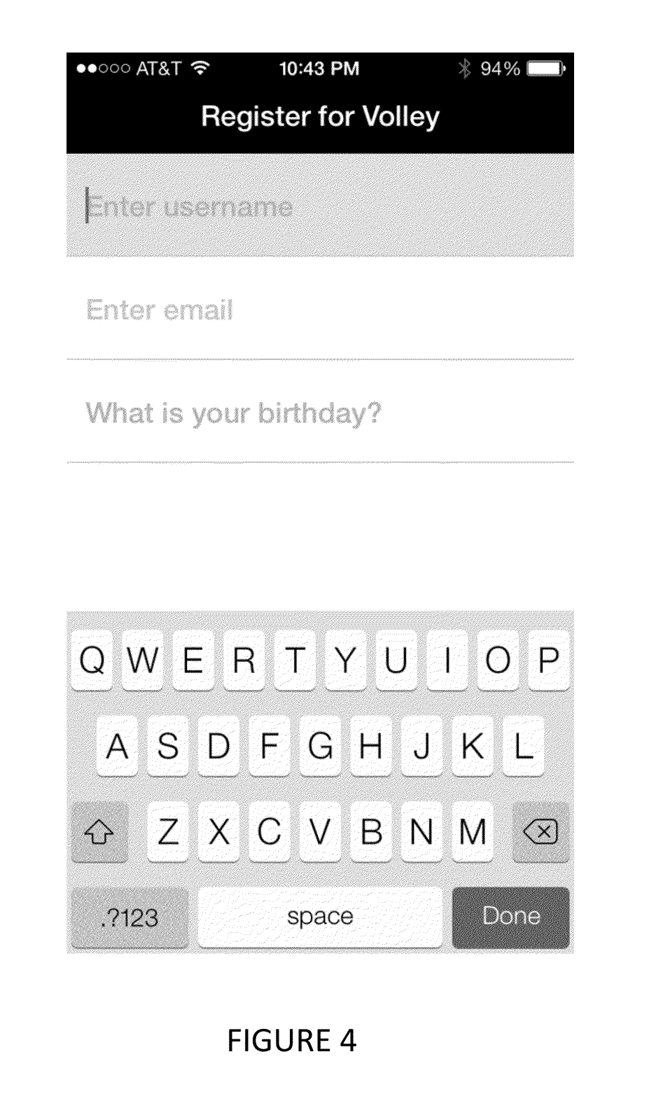

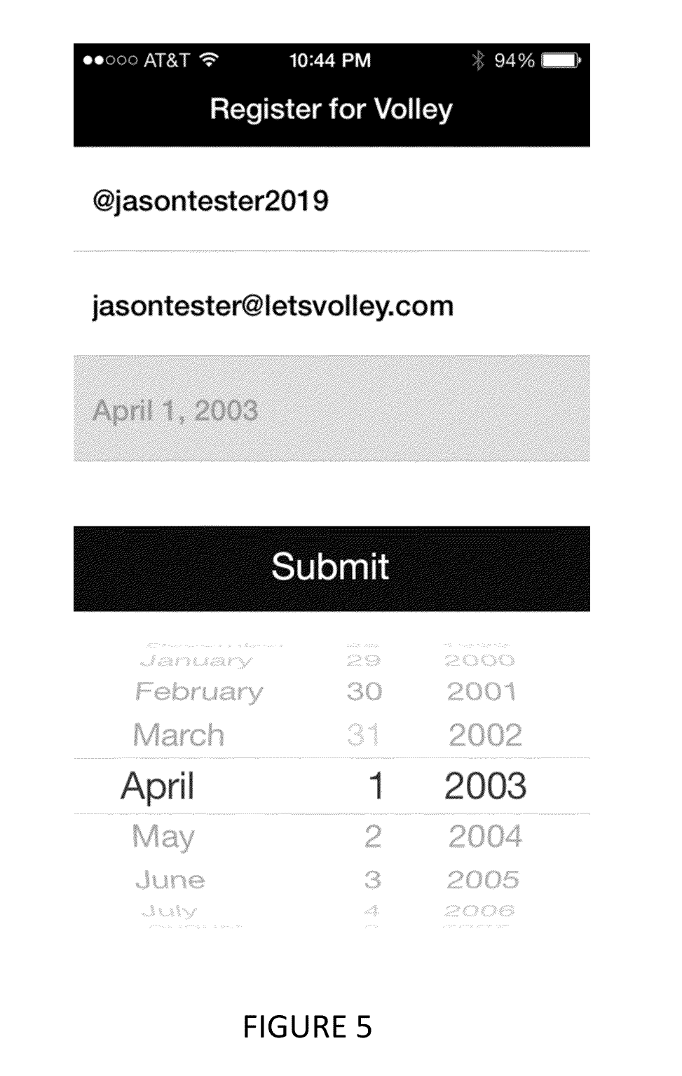

Embodiments of the present disclosure may further request (125) and receive (130) information regarding the user. The information regarding the user may be requested and/or received from the user him/herself, as well as from other sources (such as searches of Internet sites and databases). In some embodiments, the user may be asked, via the client device, to provide information such as the user's age or birthdate, contact information, and/or the user's current location. FIGS. 4 and 5 illustrate exemplary screenshots requesting that a user provide the user's username, email address, and birthday.

An initial (first) verification of the user may be performed based on an analysis of various combinations of: the image of the user, the information regarding the client device, the information regarding the image, and/or the information regarding the user. For example, the first verification of the user may include analyzing information regarding the image of the user and information regarding the user's client device to determine whether the client device captured the image of the user, as well as whether the image was captured within a predetermined period of time from the request for the image (105). In one embodiment, this analysis includes determining whether a time stamp on the image corresponds to a time the client device's camera was activated (e.g., as determined by a social media application operating in conjunction with embodiments of the present disclosure or by other software running on the client device). Among other things, this helps to determine whether the provided image was actually taken by the client device in response to the request, or whether it is an image from another source (e.g., pulled from the Internet) and/or it is an older image that may have been doctored using an image modification program.

Information regarding the client device may include data from various sensors, such as accelerometers. The first verification of the user may include analyzing the data from such sensors to determine the orientation of the client device and/or camera in the client device at the time when the camera is activated to capture the image of the user. Among other things, this can help to determine whether the user is taking an image of another image (i.e., lying on a desk) or whether the user is holding the client device/camera in an orientation consistent with taking a “selfie.”

In some embodiments, performing the first verification of the user may include receiving information about the user that includes the user's current location. In one embodiment, the user is requested (125) to provide the user's current location. The user's response (130) is then checked, as part of the first verification, against the information for the client device that includes the location of the client device (e.g., determined via global positioning system hardware and software operating on the client device). Likewise, the location provided by the user may be compared to an image analysis of the background of the image provided by the user. In one such example, a landmark in the background (e.g., the Eiffel tower) would indicate the user is currently in Paris, France, but the user indicates he is in London, England—therefore indicating the picture may be a fake, or that the user is lying as to his current location.

The success or failure of the first verification of the user may be determined based on a number of factors. For example, the first verification may be deemed unsuccessful in response to a predetermined number of requests for the user's image and/or information about the user going unanswered or to which a response was not received within a predetermined period of time from when the image/information was requested. The first verification may also be determined to be unsuccessful in response to any actual or potential issues with the validity of the image from the user or the information regarding the image, user, and/or client device. For example, the first verification may be determined to be unsuccessful where information about the user does not match previously-received information about the user.

The first verification may be determined to be unsuccessful in response to a single inconsistency between the data analyzed, or multiple inconsistencies may be allowed before the verification is deemed unsuccessful. In some embodiments, the nature of the inconsistency may be weighted in determining the success or failure of the first verification. For example, multiple inconsistencies related to data provided by the user about him/herself may be permitted where the inconsistencies appear to be typographical errors, whereas a single instance where the user appears to intentionally submit a fake image of him/herself, doctors the image in any way, or otherwise commits a deceptive act, may result in the first verification being unsuccessful. Moreover, an act of deception by the user may result in a permanent ban from further use of a social network. Such a ban may be enforced using information retrieved from the user's client device (e.g., the user's Internet protocol address or device-specific identifier) to help ensure the user is not able to create another account under a different name using the same client device.

When the first verification is unsuccessful, usage of the user's account may be disabled (140), as is the case where the second verification (discussed below) is deemed unsuccessful. In this context, “disabling usage” may include any temporary or permanent block, whether partial or full, to any service or other feature of the social network. For example, a user that fails the first or second verification may be temporarily (e.g., for 24 hours) blocked from using some or all of the features of the social network. Alternatively, the user may have access to the user's own account and profile, but may be blocked from viewing information of other members on the social network (e.g., members not already in the user's circle of friends or contacts) until the user successfully passes the first and second verification.

Where the first verification is successful, the image of the user as well as any of the information regarding the image, client device, and/or user, may be provided to other members of the social network (145) along with a solicitation for input from the members (150) to help perform a second verification of the user (155).

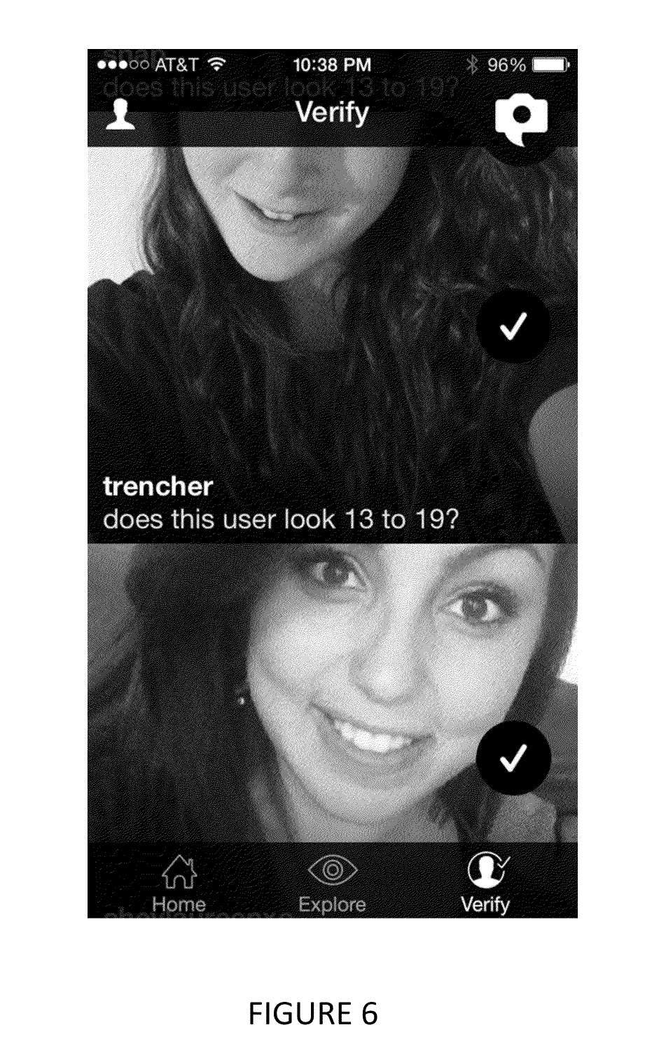

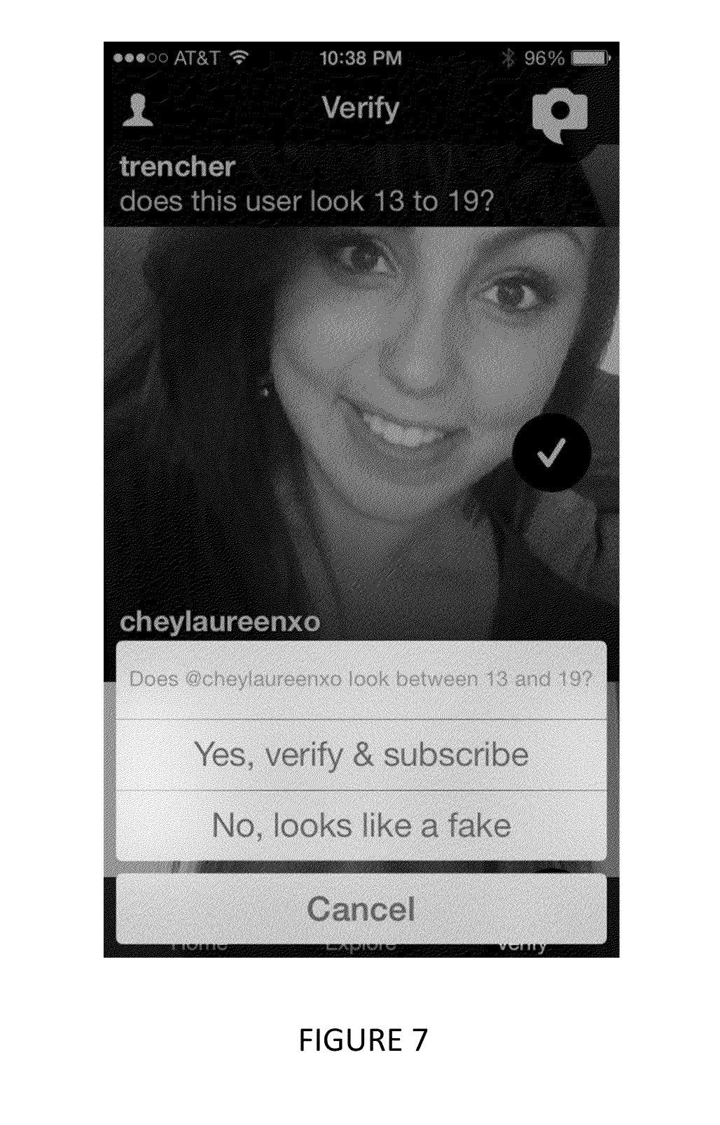

Any other suitable information may be provided to members of the social network in conjunction with the image of the user. In one embodiment the user is requested to provide information about the user that includes the user's age and/or birthdate (125). The age of the user (or an age range based on the user's birthdate) is then provided, along with the image, to members of the social network and the members are requested to indicate whether the age of the user is consistent with the age of the user from the provided image. FIGS. 6 and 7 illustrate exemplary screenshots whereby a user's image and age range is presented to members of a social network, wherein the members can provide a positive response (i.e. “yes, verify and subscribe”) or a negative response (i.e., “no, looks like a fake”). Among other things, this helps to identify users of social networks that misrepresent their age, as well as to discourage unscrupulous individuals from creating accounts on social networks protected by embodiments of the present disclosure in the first place.

The responses of the members of the social network to the image of the user may be tracked in order to determine an overall verification score for the user. In one embodiment, positive and negative responses from members of the social network are received and tracked, and the second verification is determined to be successful only where the positive responses outweigh the negative responses by a predetermined threshold. The success or failure of the second verification may be based on other factors, in addition to the responses of the social network members. The positive and negative responses by the members may be weighted equally (i.e., a positive response from one member cancels out a negative response from another), or the responses may be weighted differently based on the characteristics of the member providing the response (e.g., the member's own verification score, the length of time the member has belonged to the social network, the number of friends or connections the member has within the social network, whether the member pays a subscription fee to be a “premium member,” or other characteristics).

In some embodiments, the response of one member or a select group of members may be determinative as to whether the second verification is successful or unsuccessful. For example, where the image of the user is requested (105) in response to the user requesting access to information about a particular target member of the social network (e.g., to view the target user's images stored on the social network), the second verification may be deemed unsuccessful unless the target member provides a positive input in response to the user's image or other information. In this context, the failure of the second verification may still allow the user access to all other features of the social network, but the user will not be able to access the information of the target user. In addition to providing the advantages of the secondary verification by other users, this allows individual social network members the ability to see who is attempting to view their information and selectively control access to it.

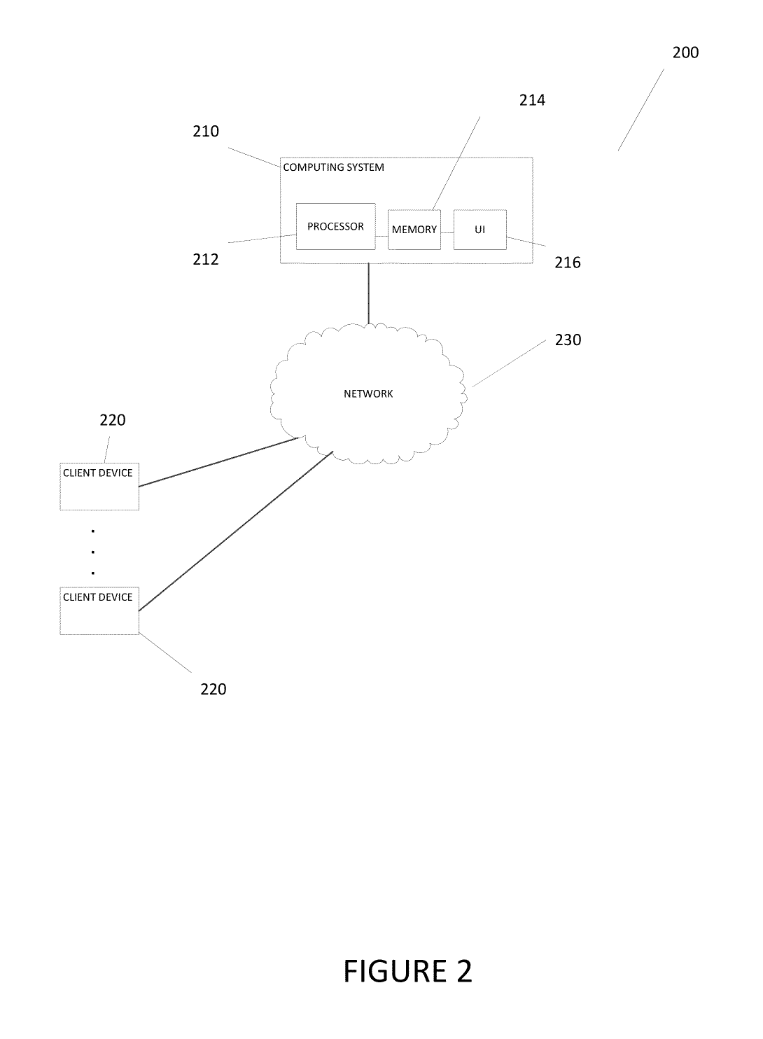

FIG. 2 is a block diagram of system which may be used in conjunction with various embodiments. While FIG. 2 illustrates various components of a computer system, it is not intended to represent any particular architecture or manner of interconnecting the components. Other systems that have fewer or more components may also be used.

In FIG. 2, the system 200 includes a computer system 210 comprising a processor 212, memory 214, and user interface 216. Computer system 210 may include any number of different processors, memory components, and user interface components, and may interact with any other desired systems and devices in conjunction with embodiments of the present disclosure.

The functionality of the computer system 210, including the method depicted in FIG. 1, (in whole or in part), may be implemented through the processor 212 executing computer-readable instructions stored in the memory 214 of the system 210. The memory 214 may store any computer-readable instructions and data, including software applications, applets, and embedded operating code. Portions of the functionality of the method depicted in FIG. 1 may also be performed via software operating on one or more of the client devices 220, such as via social media applications.

The functionality of the system 210 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 212 retrieves and executes instructions stored in the memory 214 to control the operation of the system 210. Any type of processor, such as an integrated circuit microprocessor, microcontroller, and/or digital signal processor (DSP), can be used in conjunction with embodiments of the present disclosure. A memory 214 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 214 in any desired manner, such as in a relational database.

The system 210 includes a user interface 216 that may include any number of input devices (not shown) to receive commands, data, and other suitable input. The user interface 216 may also include any number of output devices (not shown) to provides the user with data, notifications, and other information. Typical I/O devices may include mice, keyboards, modems, network interfaces, printers, scanners, video cameras and other devices.

The system 210 may communicate with one or more client devices 220, as well as other systems and devices in any desired manner, including via network 230. The client devices 220 may include, or be coupled to, one or more control systems (not shown) through which the system 210 communicates with, or the system 210 may communicate directly with the sensors 220.

The system 210 and/or client devices 220 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device.

The network 230 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: shipping data, package data, and/or any data useful in the operation of the system.

Various functionality may be performed via a web browser and/or application interfacing utilizing a web browser. Such browser applications may comprise Internet browsing software installed within a computing unit or a system to perform various functions. These computing units or systems may take the form of a computer or set of computers, and any type of computing device or systems may be used, including laptops, notebooks, tablets, hand held computers, personal digital assistants, set-top boxes, workstations, computer-servers, main frame computers, mini-computers, PC servers, network sets of computers, personal computers and tablet computers, such as iPads, iMACs, and MacBooks, kiosks, terminals, point of sale (POS) devices and/or terminals, televisions, or any other device capable of receiving data over a network. Various embodiments may utilize Microsoft Internet Explorer, Mozilla Firefox, Google Chrome, Apple Safari, Opera, or any other of the myriad software packages available for browsing the internet.

Various embodiments may operate in conjunction with any suitable operating system (e.g., Windows NT, 95/98/2000/CE/Mobile/, Windows 7/8, OS2, UNIX, Linux, Solaris, MacOS, PalmOS, etc.) as well as various conventional support software and drivers typically associated with computers. Various embodiments may include any suitable personal computer, network computer, workstation, personal digital assistant, cellular phone, smart phone, minicomputer, mainframe or the like. Embodiments may implement security protocols, such as Secure Sockets Layer (SSL), Transport Layer Security (TLS), and Secure Shell (SSH). Embodiments may implement any desired application layer protocol, including http, https, ftp, and sftp.

The various system components may be independently, separately or collectively suitably coupled to a network via data links which includes, for example, a connection to an Internet Service Provider (ISP) over the local loop as is typically used in connection with standard modem communication, cable modem, satellite networks, ISDN, Digital Subscriber Line (DSL), or various wireless communication methods. It is noted that embodiments of the present disclosure may operate in conjunction with any suitable type of network, such as an interactive television (ITV) network.

The system may be partially or fully implemented using cloud computing. “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Various embodiments may be used in conjunction with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

Any databases, systems, devices, servers or other components of the system may be located at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Embodiments may connect to the Internet or an intranet using standard dial-up, cable, DSL or any other Internet protocol known in the art. Transactions may pass through a firewall in order to prevent unauthorized access from users of other networks.

The computers discussed herein may provide a suitable website or other Internet-based graphical user interface which is accessible by users. For example, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In another example, an Apache web server can be used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet.

Various embodiments may employ any desired number of methods for displaying data within a browser-based document. For example, data may be represented as standard text or within a fixed list, scrollable list, drop-down list, editable text field, fixed text field, pop-up window, and the like. Likewise, embodiments may utilize any desired number of methods for modifying data in a web page such as, for example, free text entry using a keyboard, selection of menu items, check boxes, option boxes, and the like.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present invention. These and other changes or modifications are intended to be included within the scope of the present disclosure, as expressed in the following claims.

What is claimed is:

1. A computer-implemented method comprising:
requesting, by a computer system, an image of a user of a client device;
receiving the image of the user from the client device by the computer system;
receiving information regarding the client device by the computer system;
performing, by the computer system, a first verification of the user based on the image of the user and the information regarding the client device;
in the event the first verification of the user is unsuccessful, disabling usage of an account associated with the user on a social media network; and
in the event the first verification of the user is successful:
providing the image of the user to a plurality of members of the social network;
soliciting input from the plurality of members of the social network regarding the image of the user;
performing a second verification of the user based on the input from the plurality of members of the social network;
in the event the second verification of the user is unsuccessful, disabling usage of the account associated with the user on the social network; and
in the event the second verification of the user is successful, enabling usage of the account associated with the user on the social network.

2. The method of claim 1, further comprising receiving information regarding the image of the user.

3. The method of claim 2, wherein receiving the information regarding the image of the user includes one or more of: retrieving meta data from the image of the user, receiving information regarding the image from the user via the client device, and performing a web image search to identify one or more images similar to the image of the user.

4. The method of claim 2, wherein performing the first verification of the user includes analyzing the information regarding the image and the information regarding the client device to determine whether the client device captured the image of the user.

5. The method of claim 4, wherein performing the first verification of the user includes analyzing the information regarding the image and the information regarding the client device to determine whether the client device captured the image of the user within a predetermined period of time from the request for the image.

6. The method of claim 4, wherein performing the first verification of the user includes analyzing the information regarding the image and the information regarding the client device to determine whether a time stamp on the image corresponds to a time a camera was activated on the client device.

7. The method of claim 4, wherein the information regarding the client device includes data from one or more sensors in the client device, and wherein performing the first verification of the user includes analyzing the data from the one or more sensors to determine an orientation of one or more of the client device and a camera in the client device when the image of the user was captured.

8. The method of claim 1, wherein performing the second verification of the user includes tracking positive and negative responses from the plurality of members of the social network to determine a score for the user, and wherein the second verification is determined to be successful in response to the positive responses exceeding the negative responses in the user's score by a predetermined threshold and unsuccessful otherwise.

9. The method of claim 8, wherein the positive and negative responses from the plurality of members of the social network are weighted, based a score for each respective member, when determining the user's score.

10. The method of claim 1, wherein the information regarding the client device includes one or more of:
a manufacturer of the client device;
a model of the client device;
information regarding a camera coupled to the client device;
a unique device identifier for the client device;
a telephone number used by the client device;
an email address used by the client device;
an internet protocol address used by the client device;
a media access control address associated with the client device;
an integrated circuit card identifier associated with a subscriber identity module in the client device; and
an international mobile subscriber identifier associated with a subscriber identity module in the client device.

11. The method of claim 1, further comprising requesting the user to provide information about the user via the client device.

12. The method of claim 11, wherein performing the first validation of the user includes analyzing the information about the user.

13. The method of claim 11, wherein performing the first validation includes determining whether the user provides the information about the user within a predetermined period of time from the request to provide the information about the user.

14. The method of claim 11, wherein the information about the user includes one or more of:
an age of the user;
contact information for the user; and
a current location of the user.

15. The method of claim 11, wherein the information about the user includes an age of the user, wherein the age of the user is provided to the plurality of members of the social network along with the image of the user, and wherein soliciting input from the plurality of members includes soliciting the plurality of members of the social network to indicate whether the age of the user is consistent with the image of the user.

16. The method of claim 11, wherein the information about the user includes a current location of the user, wherein the information regarding the client device includes a current location of the client device, and wherein performing the first verification of the user includes determining whether the current location of the user matches the current location of the client device.

17. The method of claim 1, wherein the request for the image of the user is provided in response to one or more of: a request by the user to access information regarding a member of the social network, and a request by the user to retrieve a password for accessing the social network.

18. The method of claim 17, wherein the request for the image of the user is provided in response to a request to access information regarding a target member of the social network, and wherein the second validation of the user is not successful unless the target member of the social network provides positive input in response to the input solicited regarding the image of the user.

19. A non-transitory, computer-readable medium storing instructions that, when executed, cause a computing device to:
request an image of a user of a client device;
receive the image of the user from the client device;
receive information regarding the client device;
perform a first verification of the user based on the image of the user and the information regarding the client device;
in the event the first verification of the user is unsuccessful, disable usage of an account associated with the user on a social media network; and
in the event the first verification of the user is successful:
provide the image of the user to a plurality of members of the social network;
solicit input from the plurality of members of the social network regarding the image of the user;
perform a second verification of the user based on the input from the plurality of members of the social network;
in the event the second verification of the user is unsuccessful, disable usage of the account associated with the user on the social network; and
in the event the second verification of the user is successful, enable usage of the account associated with the user on the social network.

20. A system comprising:
at least one processor; and
memory in communication with the at least one processor and storing instructions that, when executed by the processor, cause the system to:
request an image of a user of a client device;
receive the image of the user from the client device;
receive information regarding the client device;
perform a first verification of the user based on the image of the user and the information regarding the client device;
in the event the first verification of the user is unsuccessful, disable usage of an account associated with the user on a social media network; and
in the event the first verification of the user is successful:
provide the image of the user to a plurality of members of the social network;
solicit input from the plurality of members of the social network regarding the image of the user;
perform a second verification of the user based on the input from the plurality of members of the social network;
in the event the second verification of the user is unsuccessful, disable usage of the account associated with the user on the social network; and
in the event the second verification of the user is successful, enable usage of the account associated with the user on the social network.
